(19) United States
(12) Patent Application Publication
(10) Pub. No.: US 2014/0074303 A1
(43) Pub. Date: Mar. 13, 2014

(54) TWO-WIRE TRANSMITTER TERMINAL POWER DIAGNOSTICS

(71) Applicants: Kevin M. Haynes, Lombard, IL (US); Eric C. Moore, Lake in the Hills, IL (US)

(72) Inventors: Kevin M. Haynes, Lombard, IL (US); Eric C. Moore, Lake in the Hills, IL (US)

(21) Appl. No.: 13/608,231

(22) Filed: Sep. 10, 2012

(51) Int. Cl. G06F 1/26

(52) U.S. Cl. 700/286

(57) ABSTRACT

A loop powered process instrument comprises a signal processing circuit measuring a process variable and developing a measurement signal representing the process variable. A control system, for connection to a power supply using a two-wire process loop, controls current on the loop in accordance with the measurement signal. The control system implements a diagnostic function comprising selectively controlling loop current at first and second select current levels and measuring terminal voltage at each of the first and second select current levels to determine if power supply voltage is at a select voltage level.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to process control instruments, and more particularly, to a two-wire, loop powered instrument with terminal power diagnostics.

### BACKGROUND

Process control systems require the accurate measurement of process variables. Typically, a primary element senses the value of a process variable and a transmitter develops an output having a value that varies as a function of the process variable. For example, a level transmitter includes a primary element for sensing level and a circuit for developing an electrical signal proportional to sensed level.

An electrical transmitter must be connected to an electrical power source to operate. One form of such a transmitter, known as a four-wire transmitter, includes two terminals for connection to a power source and two terminals for carrying an output signal proportional to the process variable. This signal can be used as an input to a controller or for purposes of indication. Because the instrument is connected directly to a power source independent from the output signal, power consumption is a less critical factor in design and use of the same.

The use of a four-wire transmitter, as discussed above, requires the use of four conductors between the transmitter and related loop control and power components. Where transmitters are remotely located, such a requirement can be undesirable owing to the significant cost of cabling. To avoid this problem, instrument manufacturers have strived to develop devices known as two-wire, or loop powered, transmitters. A two-wire transmitter includes two terminals connected to a remote power supply. The transmitter loop current, drawn from the power supply, is proportional to the process variable. A typical instrument operates off of a 24 volt DC power supply and varies the signal current in the loop between four and twenty milliamps (mA) DC. Thus, the instrument must operate with current less than four milliamps.

The operation of a two-wire transmitter is dependent on the power supply and the loop resistance between the power supply and the two-wire transmitter. As transmitters become more complicated and require increased power for successful operation, it has become critical that the transmitter be able to diagnose power supply problems to prevent erroneous indication of the process conditions.

Particularly, the available power and loop resistance can change over time. As current increases, if the power drops due to high resistance, then the transmitter may fail. Changes can occur if additional transmitters are added to the power supply circuit, or may result, for example, from contact resistance changes such as from terminals vibrating loose.

With known two-wire transmitters the performance can degrade due to insufficiency of terminal power. Testing can be performed manually to confirm that there is a sufficient supply. However, testing may not always be convenient.

The present invention is directed to solving one or more of the problems discussed above in a novel and simple manner.

### SUMMARY

In accordance with the invention, a transmitter monitors terminal voltage to monitor the supply condition.

There is disclosed in accordance with one aspect of the invention a loop powered process instrument comprising a signal processing circuit measuring a process variable and developing a measurement signal representing the process variable. A control system, for connection to a power supply using a two-wire process loop, controls current on the loop in accordance with the measurement signal. The control system implements a diagnostic function comprising selectively controlling loop current at first and second select current levels and measuring terminal voltage at each of the first and second select current levels to determine if power supply voltage is at a select voltage level.

There is disclosed in accordance with another aspect of the invention a two-wire transmitter with terminal power diagnostics comprising a signal processing circuit measuring a process variable and developing a measurement signal representing the process variable. A control system includes a programmed processor for receiving the measurement signal and developing a current output signal. A two-wire circuit is provided for connection to a power supply using a two-wire process loop. The two-wire circuit controls current on the loop in accordance with the current output signal. The control system implements a diagnostic function comprising selectively controlling the loop current signal at first and second select current levels and measuring terminal voltage at each of the first and second select current levels to determine if power supply voltage is at a select voltage level.

It is a feature that the control circuit comprises a digital to analog converter circuit between the programmed processor and the two-wire circuit.

It is another feature that the diagnostic function is implemented at start up.

It is a further feature that the control system uses loop current and terminal voltage to determine loop resistance. The control system uses loop current, terminal voltage and loop resistance to determine supply voltage.

It is another feature that the control system comprises a loop feedback circuit to measure loop current and a power feedback circuit to measure terminal voltage.

It is yet another feature that the control system comprises a display for displaying a low supply voltage warning message if power supply voltage is below the select voltage level.

It is an additional feature that the control system transmits a fault message on the loop if power supply voltage is below the select voltage level.

It is an additional feature that the control system controls loop current at a safe fault condition if power supply voltage is below the select voltage level.

Other features and advantages will be apparent from a review of the entire specification, including the appended claims and drawings.

### BRIEF DESCRIPTION OF THE DRAWINGS

FIG. 1 is an elevation view of a two-wire transmitter with terminal power diagnostics;

FIG. 2 is a block diagram of the transmitter of FIG. 1;

FIG. 3 is schematic of a process control system using the transmitter of FIG. 1;

FIG. 4 is a schematic of a power feedback circuit of the transmitter of FIG. 1;

FIG. 5 is a schematic of a loop current feedback circuit of the transmitter of FIG. 1; and

FIG. 6 is a flow diagram of a terminal power diagnostics routine implemented in the processor of FIG. 2.

### DETAILED DESCRIPTION

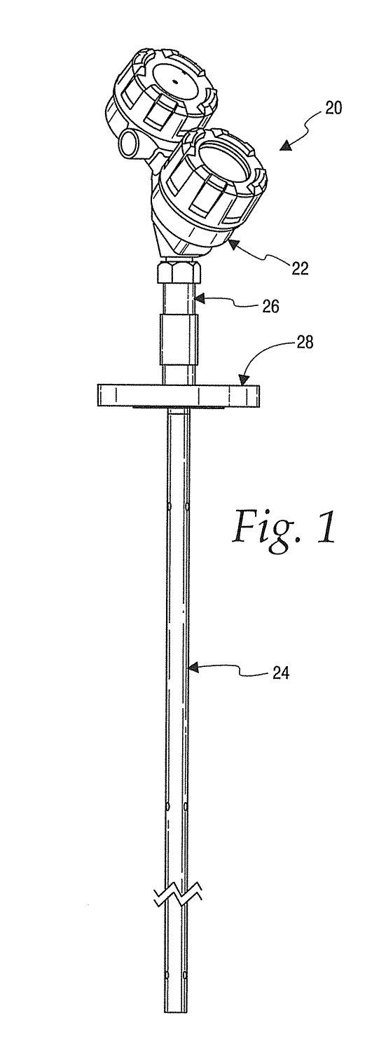

Referring to FIG. 1, a process instrument 20 is illustrated. The process instrument 20 uses pulsed radar in conjunction with equivalent time sampling (ETS) and ultra-wide band (UWB) transceivers for measuring level using time domain reflectometry (TDR). Particularly, the instrument 20 uses guided wave radar for sensing level. While the embodiment described herein relates to a guided wave radar level sensing apparatus, various aspects of the invention may be used with other types of process instruments for measuring various process parameters.

The process instrument 20 includes a control housing 22, a probe 24, and a connector 26 for connecting the probe 24 to the housing 22. The probe 24 is mounted to a process vessel (not shown) using a flange 28. The housing 22 is then secured to the probe 24 as by threading the connector 26 to the probe 24 and also to the housing 22. The probe 24 comprises a high frequency transmission line which, when placed in a fluid, can be used to measure level of the fluid. Particularly, the probe 24 is controlled by a controller, described below, in the housing 22 for determining level in the vessel.

As described more particularly below, the controller in the housing 22 generates and transmits pulses on the probe 24. A reflected signal is developed off any impedance changes, such as the liquid surface of the material being measured. A small amount of energy may continue down the probe 24.

Guided wave radar combines TDR, ETS and low power circuitry. TDR uses pulses of electromagnetic (EM) energy to measure distanced or levels. When a pulse reaches a dielectric discontinuity then a part of the energy is reflected. The greater the dielectric difference, the greater the amplitude of the reflection. In the measurement instrument 20, the probe 24 comprises a wave guide with a characteristic impedance in air. When part of the probe 24 is immersed in a material other than air, there is lower impedance due to the increase in the dielectric. Then the EM pulse is sent down the probe it meets the dielectric discontinuity, a reflection is generated.

ETS is used to measure the high speed, low power EM energy. The high speed EM energy (1000 foot/microsecond) is difficult to measure over short distances and at the resolution required in the process industry. ETS captures the EM signals in real time (nanoseconds) and reconstructs them in equivalent time (milliseconds), which is much easier to measure. ETS is accomplished by scanning the wave guide to collect thousands of samples. Approximately eight scans are taken per second.

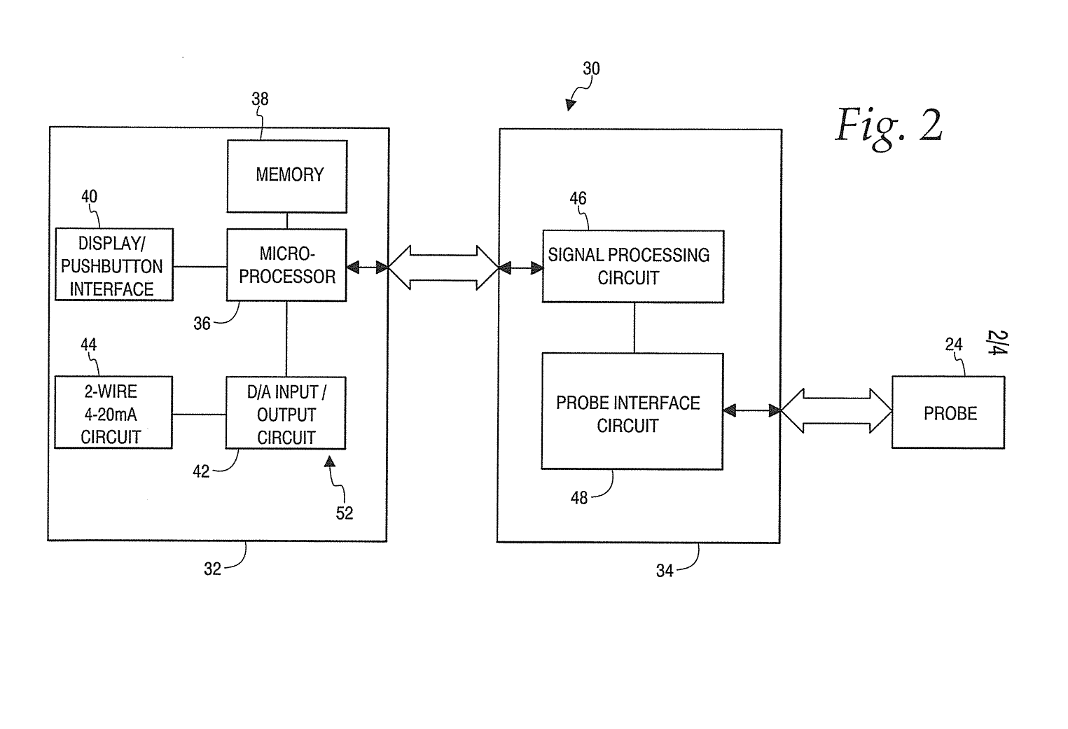

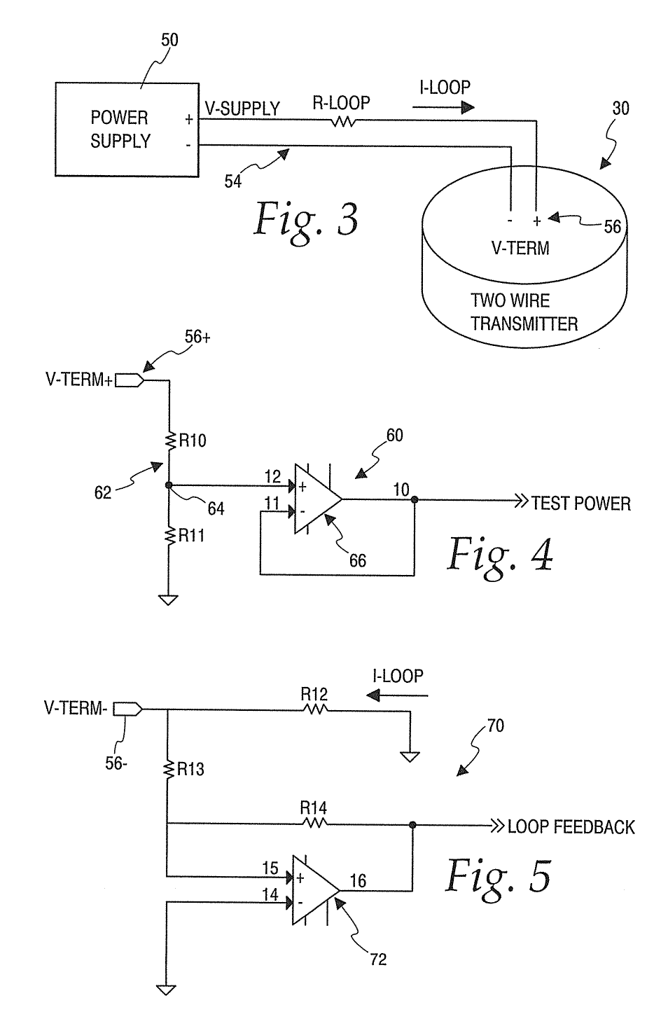

Referring to FIG. 2, the electronics mounted in the housing 22 of FIG. 1 are illustrated in block diagram form as a controller 30 connected to the probe 24. The controller 30 includes a digital circuit 32 and an analog circuit 34. The digital circuit 32 includes a microprocessor 36 connected to a suitable memory 38 (the combination forming a computer) and a display/push button interface 40. The display/push button interface 40 is used for entering parameters with a keypad and displaying user and status information. The memory 38 comprises both non-volatile memory for storing programs and calibration parameters, as well as volatile memory used during level measurement. The microprocessor 36 is also connected to a digital to analog input/output circuit 42 which is in turn connected to a two-wire circuit 44 for connecting to a remote power source. Particularly, the two-wire circuit 44 utilizes loop control and power circuitry which is well known and commonly used in process instrumentation. The power is provided on the line from an external power supply 50, see FIG. 3. The two-wire circuit 44 controls the current on the two-wire line in the range of 4-20 mA which represents level or other characteristics measured by the probe 24.

The controller 30 may have the capability of implementing digital communications through the two-wire circuit 44 with remote devices and the outside world. Such communication preferably uses the HART protocol, but could also use fieldbus protocols such as Foundation Fieldbus or Profibus PA.

The microprocessor 36 is also connected to a signal processing circuit 46 of the analog circuit 34. The signal processing circuit 46 is in turn connected via a probe interface circuit 48 to the probe 24. The probe interface circuit 48 includes an ETS circuit which converts real time signals to equivalent time signals, as discussed above. The signal processing circuit 44 processes the ETS signals and provides a timed output to the microprocessor 36, as described more particularly below.

The general concept implemented by the ETS circuit is known. The probe interface circuit 48 generates hundreds of thousands of very fast pulses of 500 picoseconds or less rise time every second. The timing between pulses is tightly controlled. The reflected pulses are sampled at controlled intervals. The samples build a time multiplied “picture” of the reflected pulses. Since these pulses travel on the probe 24 at the speed of light, this picture represents approximately ten nanoseconds in real time for a five-foot probe. The probe interface circuit 48 converts the time to about seventy-one milliseconds. As is apparent, the exact time would depend on various factors, such as, for example, probe length. The largest signals have an amplitude on the order of twenty millivolts before amplification to the desired amplitude by common audio amplifiers. For a low power device, a threshold scheme is employed to give interrupts to the microprocessor 36 for select signals, namely, fiducial, target, level, and end of probe, as described below. The microprocessor 36 converts these timed interrupts into distance. With the probe length entered through the display/push button interface 40, or some other interface, the microprocessor 36 can calculate the level by subtracting from the probe length the difference between the fiducial and level distances.

In accordance with the invention, the digital circuit 32 defines a control system 52 for controlling operation of the instrument 20 to measure level using the programmed processor 36. The control system 52 implements a diagnostic function to selectively monitor terminal power. In use, the controller 30 is connected in a “loop” 54 to the power supply 50, see FIG. 3. The controller 30 controls current on the loop 54 in accordance with the measurement signal. The diagnostic function comprises selectively controlling loop current at first and second select current levels and measuring terminal voltage at each of the first and second select current levels to determine if power supply voltage is at a select, sufficient voltage level to ensure proper operation.

Particularly, and with reference to FIG. 3, the power supply 50 may comprise, for example, a 24 Volt DC supply across terminals + and − with the voltage level being defined as V-SUPPLY. The two-wire transmitter controller 30 includes terminals 56 labeled + and − and being defined as V-TERM. The + terminals of the power supply 50 and the controller 30 are interconnected as are the − terminals, as shown. The two-wire current loop 54 has a characteristic resistance identified as R-LOOP.

To monitor the supply condition the control system 52 uses feedback circuits to monitor the voltage at the power terminals 56. A voltage feedback circuit 60, see FIG. 4, establishes a signal called Test Power which is derived from the terminal voltage. This signal goes to one of the microprocessor A/D inputs. From the signal Test Power the actual terminal voltage, V-TERM, can be determined. The control system 52 also monitors the actual loop current that is drawn by the transmitter controller 30. A loop feedback circuit 70, see FIG. 5, is used to establish a voltage that is a function of the loop current, I-LOOP. This signal also goes to one of the microprocessor A/D inputs. The microprocessor 36 uses values of V-TERM and I-LOOP to perform the Terminal Power Diagnostics (TPD) to determine if the input power is sufficient for the unit. If the power is considered to be a potential problem over normal loop current operation the unit can display a warning message such as “Low Supply Voltage”

FIG. 4 illustrates the power feedback circuit 60. The V-TERM+ terminal 56+ is connected to a voltage divider 62 comprising series connected resistors R10 and R11 to ground. A node 64 between the resistors R10 and R11 is connected to the non-inverted input of an amplifier 66. The amplifier output develops the Test Power feedback voltage. The amplifier output is also connected back to the inverted input.

Referring to FIG. 5, a schematic diagram illustrates the current feedback circuit 70. This circuit 70 includes a resistor R12 connected between ground and the V-TERM− terminal 56−. The loop current I-LOOP, generator under control of the microprocessor 36, passes through the resistor R12. The terminal 56− is connected via a resistor R13 to the non-inverted input of an amplifier 72. The inverted input is connected to ground. A resistor R 14 is connected across the non-inverted input and the output of the amplifier 72. The output of the amplifier 72 represents the loop current feedback to the microprocessor 36.

As described herein, the microprocessor 36 operates in accordance with a terminal power diagnostics (TPD) program to monitor the supply conditions at the power terminals 56. The TPD program makes use of terminal power to assess the system set-up. By testing two terminal voltages at two different loop currents, the controller 30 can evaluate the unit's power supply 52 and loop resistance R-LOOP, as shown below.

The loop resistance external to the unit can be calculated with the following equation:

R-LOOP=(V-TERM-1−V-TERM-2)/(I-LOOP-2−I-LOOP-1).

The supply voltage available to the transmitter 20 is calculated using the following equation:

V-supply=V-TERM-1+I-LOOP-1*R-LOOP.

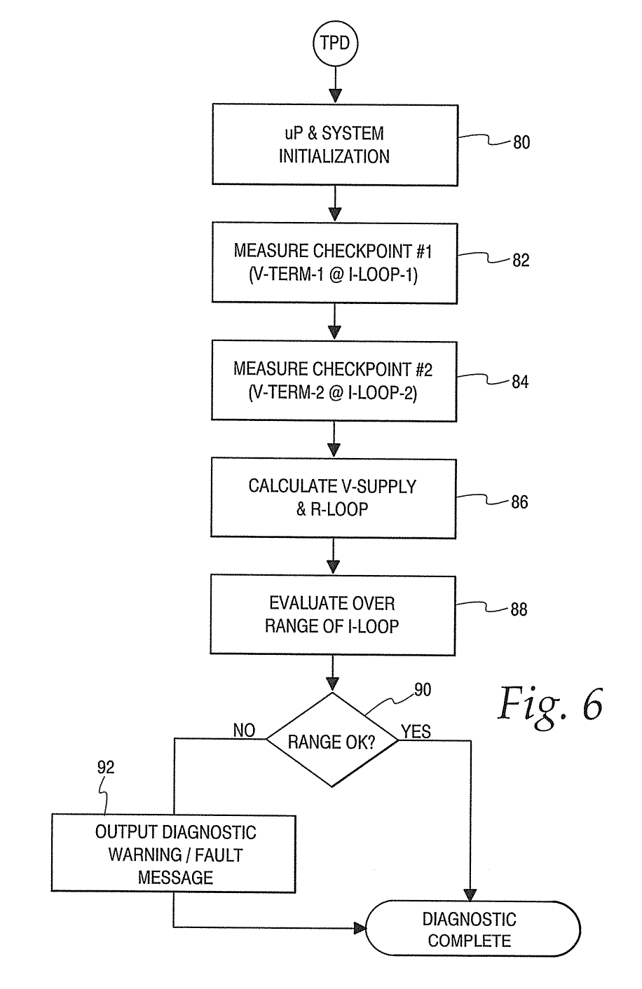

Referring to FIG. 6, a flow diagram illustrates the TPD program implemented in the microprocessor 36. The TPD program is implemented at processor and system initialization as indicated at a block 80. At a block 82 the processor 36 takes measurements for a first check point by selectively controlling the 2-wire circuit 44 to generate loop current at a first level and measuring terminal voltage at the first current level. As will be apparent, the actual measured loop current may differ from the commanded loop current. This produces the feedback values V-TERM-1 and I-LOOP-1. Subsequently, at a block 84, the processor 36 takes measurements for a second check point by selectively controlling the 2-wire circuit 44 to generate loop current at a second level and measuring terminal voltage at the second current level. This produces the feedback values V-TERM-2 and I-LOOP-2. A block 86 then calculates the values R-LOOP and V-SUPPLY using the equations noted above.

The program then evaluates the operation over a normal range of loop current, represented by the first and second current levels, at a block 88. This may comprise, for example, comparing the value V-SUPPLY to a select voltage level. A decision block 90 determines if the range is OK. If so, then the diagnostic is complete. If not, then a diagnostic warning or fault message is output at a block 92. The diagnostic may comprise a warning displayed on the display 40. Alternatively, a fault message can be communicated over the two-wire loop 54 to the external control system. Also, if the loop current falls out of control, then the control system 52 can create a fault message and take the loop current to a safe fault condition.

With the monitored values the control system 52 can make calculations to assure that the control circuit 30 will always operate properly. With this knowledge the control system 52 warns the customer of the potential for improper operation even before the system exhibits improper behavior. This feature allows the customer to adjust supply voltage or loop resistance to avoid failure of the system during operation. Since these tests are performed at initial power up, most applications will receive this warning during commissioning of the system before a failure could cause critical problems.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A loop powered process instrument comprising:
a signal processing circuit measuring a process variable and developing a measurement signal representing the process variable;
a control system, for connection to a power supply using a two-wire process loop, for controlling current on the loop in accordance with the measurement signal, the control system implementing a diagnostic function comprising selectively controlling loop current at first and second select current levels and measuring terminal voltage at each of the first and second select current levels to determine if power supply voltage is at a select voltage level.

2. The loop powered process instrument of claim 1 wherein the control system comprises a programmed processor operating in accordance with a control program to implement the diagnostic function.

3. The loop powered process instrument of claim 1 wherein the diagnostic function is implemented at startup.

4. The loop powered process instrument of claim 1 wherein the control system uses loop current and terminal voltage to determine loop resistance.

5. The loop powered process instrument of claim 4 wherein the control system uses loop current, terminal voltage and loop resistance to determine supply voltage.

6. The loop powered process instrument of claim 1 wherein the control system comprises a loop feedback circuit to measure loop current.

7. The loop powered process instrument of claim 1 wherein the control system comprises a power feedback circuit to measure terminal voltage.

8. The loop powered process instrument of claim 1 wherein the control system comprises a display for displaying a low supply voltage warning message if power supply voltage is below the select voltage level.

9. The loop powered process instrument of claim 1 wherein the control system transmits a fault message on the loop if power supply voltage is below the select voltage level.

10. The loop powered process instrument of claim 1 wherein the control system controls loop current at a safe fault condition if power supply voltage is below the select voltage level.

11. A two-wire transmitter with terminal power diagnostics comprising:
a signal processing circuit measuring a process variable and developing a measurement signal representing the process variable;
a control system including a programmed processor for receiving the measurement signal and developing a current output signal, and a two wire circuit, for connection to a power supply using a two-wire process loop, for controlling current on the loop in accordance with the current output signal, the control system implementing a diagnostic function comprising selectively controlling the loop current signal at first and second select current levels and measuring terminal voltage at each of the first and second select current levels to determine if power supply voltage is at a select voltage level.

12. The two-wire transmitter of claim 11 wherein the control system comprises a digital to analog converter circuit between the programmed processor and the two-wire circuit.

13. The two-wire transmitter of claim 11 wherein the diagnostic function is implemented at startup.

14. The two-wire transmitter of claim 11 wherein the control system uses loop current and terminal voltage to determine loop resistance.

15. The two-wire transmitter of claim 14 wherein the control system uses loop current, terminal voltage and loop resistance to determine supply voltage.

16. The two-wire transmitter of claim 11 wherein the control system comprises a loop feedback circuit to measure loop current.

17. The two-wire transmitter of claim 11 wherein the control system comprises a power feedback circuit to measure terminal voltage.

18. The two-wire transmitter of claim 11 wherein the control system comprises a display for displaying a low supply voltage warning message if power supply voltage is below the select voltage level.

19. The two-wire transmitter of claim 11 wherein the control system transmits a fault message on the loop if power supply voltage is below the select voltage level.

20. The two-wire transmitter of claim 11 wherein the control system controls loop current at a safe fault condition if power supply voltage is below the select voltage level.
